(19) United States
(12) Patent Application Publication
(10) Pub. No.: US 2016/0066306 A1
(43) Pub. Date: Mar. 3, 2016

(54) INTERFACE FOR INTERFERENCE MITIGATION IN UNLICENSED FREQUENCY BANDS

(71) Applicants: Mohammad R. Khawer, Lake Hopatcong, NJ (US); Robert A. Soni, Randolph, NJ (US); Teck H. Hu, Melbourne, FL (US)

(72) Inventors: Mohammad R. Khawer, Lake Hopatcong, NJ (US); Robert A. Soni, Randolph, NJ (US); Teck H. Hu, Melbourne, FL (US)

(73) Assignee: ALCATEL-LUCENT USA INC., Murray Hill, NJ (US)

(21) Appl. No.: 14/476,029

(22) Filed: Sep. 3, 2014

(51) Int. Cl. H04W 72/04

(52) U.S. Cl. CPC H04W 72/0406; H04W 72/0446; H04W 72/0453; H04W 72/082

(57) ABSTRACT

Nodes in a wireless communication system can mitigate interference in unlicensed frequency bands by coordinating downlink transmissions. The nodes may negotiate, based on messages exchanged over an interface between a first node and at least one second node, time intervals for downlink transmissions by the first node and the at least one second node over a channel of an unlicensed frequency band in response to the at least one second node transmitting over the channel of the unlicensed frequency band.

### CROSS REFERENCE TO RELATED APPLICATIONS

This application is related to U.S. patent application Ser. No. ______, entitled “USER EQUIPMENT ASSISTANCE FOR INTERFERENCE MITIGATION IN UNLICENSED FREQUENCY BANDS” and filed on even date herewith, the entirety of which is incorporated by reference herein.

### BACKGROUND

1. Field of the Disclosure

The present disclosure relates generally to wireless communication systems and, more particularly, to unlicensed frequency bands in wireless communication systems.

2. Description of the Related Art

Unlicensed frequency bands are portions of the radiofrequency spectrum that do not require a license for use and may therefore be used by any device to transmit or receive radiofrequency signals. For example, the Unlicensed National Information Infrastructure (UNII) includes portions of the radio spectrum in frequency bands that range from 5.15 GHz to 5.825 GHz. For another example, the industrial, scientific, and medical (ISM) radio bands are portions of the radio spectrum that are reserved internationally for unlicensed communication. The ISM radio bands include bands with a center frequency of 2.4 GHz and a bandwidth of 100 MHz, a center frequency of 5.8 GHz and a bandwidth of 150 MHz, and a center frequency of 24.125 GHz and a bandwidth of 250 MHz, among other frequency bands. Unlicensed frequency bands can be contrasted to licensed frequency bands that are licensed to a particular service provider and may only be used for wireless communication that is authorized by the service provider. Wireless communication devices that transmit or receive signals in licensed or unlicensed frequency bands are typically referred to as nodes, which may include Wi-Fi access points that operate according to IEEE 802.11 standards in the unlicensed spectrum or base stations that operate in licensed spectrum according to standards such as Long Term Evolution (LTE) standards defined by the Third Generation Partnership Project (3GPP). Base stations that operate according to LTE may also implement supplementary downlink (SDL) channels in the unlicensed spectrum to provide additional bandwidth for downlink communications to user equipment that are also communicating with the base station using channels in a licensed frequency band.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided using an interface to mitigate interference in unlicensed frequency bands. The method includes negotiating, based on messages exchanged over an interface between a first node and one or more second nodes, time intervals for downlink transmissions by the first node and the one or more second nodes over a channel of an unlicensed frequency band in response to the one or more second nodes transmitting over the channel of the unlicensed frequency band.

In some embodiments, an apparatus is provided for using an interface to mitigate interference in unlicensed frequency bands. The apparatus includes a transceiver to exchange messages over an interface between a first node and at least one second node. The apparatus also includes one or more processors to negotiate, based on messages exchanged over an interface between a first node and one or more second nodes, time intervals for downlink transmissions by the first node and the one or more second nodes over a channel of an unlicensed frequency band in response to the one or more second nodes transmitting over the channel of the unlicensed frequency band.

In some embodiments, a non-transitory computer-readable medium is provided that embodies a set of executable instructions that may be used to configure a processor to use an interface to mitigate interference in unlicensed frequency bands. The set of executable instructions configures the processor to negotiate, based on messages exchanged over an interface between a first node and one or more second nodes, time intervals for downlink transmissions by the first node and the one or more second nodes over a channel of an unlicensed frequency band in response to the one or more second nodes transmitting over the channel of the unlicensed frequency band.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a first example of a wireless communication system according to some embodiments.

FIG. 2 is a diagram showing allocation of time intervals in a gating cycle for downlink transmissions by two nodes on a channel of an unlicensed frequency band according to some embodiments.

FIG. 3 is a diagram showing allocation of time intervals in a gating cycle for downlink transmissions by three nodes on a channel of an unlicensed frequency band according to some embodiments.

FIG. 4 is a diagram of a second example of a wireless communication system according to some embodiments.

FIG. 5 is a diagram of a third example of a wireless communication system according to some embodiments.

FIG. 6 is a diagram showing allocation of time intervals in a gating cycle for downlink transmissions by two nodes that operate according to a first radio access technology (RAT) and a third node that operates according to a second RAT according to some embodiments.

FIG. 7 is a flow diagram of a method for negotiating allocation of time intervals to mitigate interference on a shared channel in an unlicensed frequency band according to some embodiments.

FIG. 8 is a diagram of a fourth example of a wireless communication system according to some embodiments.

### DETAILED DESCRIPTION

Base stations may perform carrier sensing to select channels for downlink transmission in unlicensed frequency bands. For example, a base station may measure energy received in channels in the unlicensed frequency bands to identify a “clean” channel, e.g., an average of the received energy from other LTE base stations or Wi-Fi access points on the channel is below a threshold value. The base station may then use the clean channel for downlink transmissions. However, if the base station is unable to identify a clean channel, the base station has to share the channel with one or more other transmitting nodes. Base stations that operate according to LTE and the unlicensed spectrum also have to co-exist with Wi-Fi access points. For example, a base station may transmit its LTE carrier using a repeating gating cycle with a 50% duty cycle so that the LTE carrier is transmitted for half of the gating cycle and turned off for the other half of the gating cycle to minimize interference with neighboring Wi-Fi access points. Furthermore, base stations may not be able to use channels that Wi-Fi access points are using as their primary channels for transmitting beacons.

Channel sharing may be complicated by the fact that nodes such as Wi-Fi access points and LTE base stations are prone to a “hidden node problem.” For example, if two nodes are within range of the user equipment, but are too far apart to be aware of each other, the two nodes are “hidden” from each other. Nodes that are hidden from each other cannot coordinate transmission and reception of packets, e.g., to force time-sharing between the two nodes. Packets transmitted by nodes that are hidden from each other may therefore collide at a receiving node, which can only decode one packet at a time. Consequently, packets intended for the receiving node may be missed or lost if they collide with other packets transmitted by a hidden node. For example, two or more base stations transmitting over the same supplementary downlink channel in the unlicensed frequency band may interfere with each other if they use the same on/off pattern to avoid interference with one or more Wi-Fi access points during the gating cycle.

Fair sharing of unlicensed frequency band channels between nodes in a wireless communication system may be implemented by negotiating time intervals for downlink transmissions by a first node and one or more second nodes over a channel of the unlicensed frequency band in response to one or more of the second nodes transmitting over the channel of the unlicensed frequency band. The negotiations may be performed by exchanging messages over one or more interfaces between the first node and the one or more second nodes. The first node may determine whether one or more second nodes are transmitting over the channel of the unlicensed frequency band by performing energy detection. Some embodiments of the first node may also use feedback from one or more user equipment to detect (potentially hidden) second nodes.

The first node and at least one of the second nodes operate according to a first radio access technology (RAT) such as LTE. The first and second nodes that operate according to the first RAT may negotiate time intervals for time division multiplexing their respective downlink transmissions over the channel of the unlicensed frequency band. In some embodiments, the time intervals include two or more timeslots within a repeating gating cycle. The set of timeslots available to first or second nodes that operate according to the first RAT may cover the entire gating cycle if no downlink transmissions from one or more second nodes that operate according to a second RAT (such as Wi-Fi) are detected over the channel of the unlicensed frequency band. The coverage of the set of timeslots available to first or second nodes that operate according to the first RAT may be reduced to half of the gating cycle in response to detection of downlink transmissions from one or more second nodes that operate according to the second RAT. Thus, half of the gating cycle is reserved for transmission by a Wi-Fi access point if two or more LTE-U base-stations share a channel of the unlicensed frequency band with a Wi-Fi access point share the same channel. The LTE-U base-stations may negotiate among themselves (e.g., via signaling over an interface) for the use of the remaining portion of the gating cycle.

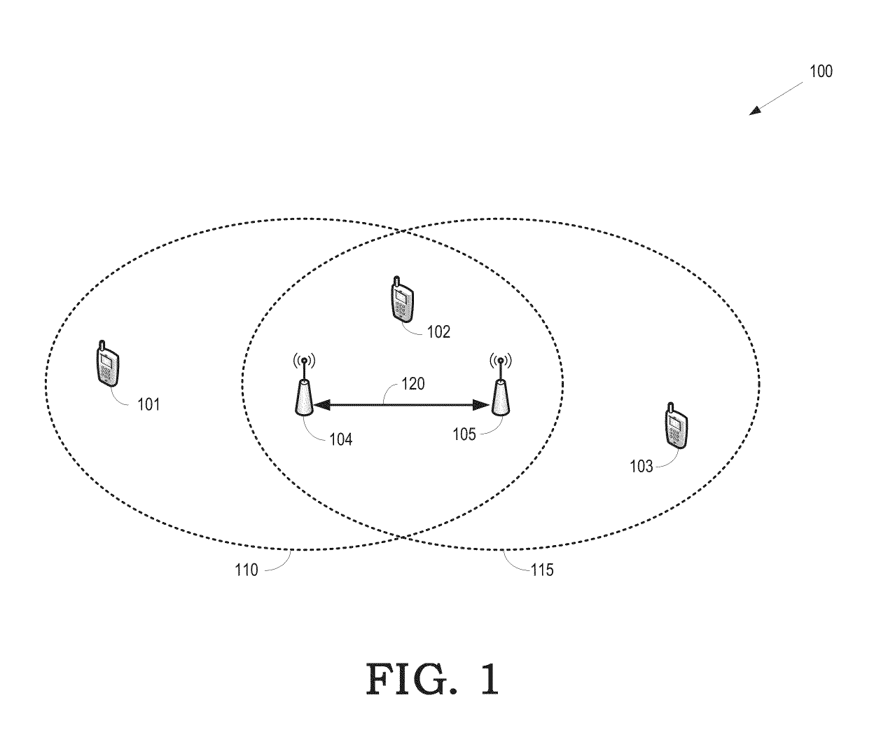

FIG. 1 is a diagram of a first example of a wireless communication system 100 according to some embodiments. The wireless communication system 100 includes a plurality of wireless communication nodes 101, 102, 103, 104, 105 (collectively referred to herein as “the nodes 101-105”). Embodiments of the nodes 101-103 may be wireless transceivers such as user equipment, mobile units, mobile terminals, stations, access terminals, and the like. Embodiments of the nodes 104, 105 may be devices for providing wireless connectivity within corresponding geographic areas that are conventionally referred to as cells 110, 115. The nodes 104, 105 may also be referred to as base stations, eNodeBs, access points, access serving networks, macrocells, microcells, metrocells, femtocells, picocells, and the like. The nodes 104, 105 may transmit signals over a downlink (or forward link) to the nodes 101-103. The nodes 101-103 may transmit signals over an uplink (or reverse link) to the nodes 104, 105.

The nodes 101-105 may be configured to communicate over an air interface in licensed frequency bands or unlicensed frequency bands. As used herein, the phrase “unlicensed frequency band” will be understood to refer to a portion of the radiofrequency spectrum that does not require a license for use and may therefore be used by any of the nodes 101-105 to transmit or receive radio frequency signals. For example, unlicensed frequency bands may include, but are not limited to, the industrial, scientific, and medical (ISM) radio bands that are reserved internationally for unlicensed communication and UNII frequency bands. Unlicensed frequency bands may be defined by a center frequency bandwidth. For example, the ISM radio bands include bands with a center frequency of 2.4 GHz and a bandwidth of 100 MHz, a center frequency of 5.8 GHz and a bandwidth of 150 MHz, and a center frequency of 24.125 GHz and a bandwidth of 250 MHz, among other frequency bands. For another example, the Unlicensed National Information Infrastructure (UNII) includes portions of the radio spectrum in frequency bands that range from 5.15 GHz to 5.825 GHz. As used herein, the phrase “licensed frequency band” will be understood to refer to a portion of the radiofrequency spectrum that is licensed to a particular service provider or providers and may only be used for wireless communication by the nodes 101-105 that are authorized by the service provider. For example, the United States Federal Communication Commission (FCC) licenses the frequency bands 698-704 MHz and 728-734 MHz to Verizon Wireless and the frequency bands 710-716 MHz and 740-746 MHz to AT&T.

The unlicensed frequency bands support a plurality of channels that may be used for downlink transmissions from the nodes 104, 105 to the nodes 101-103. For example, the 5 GHz unlicensed frequency band allocated to the UNII may be divided into a predetermined number of 20 MHz channels. Some embodiments of the nodes 104, 105 may use the channels in the unlicensed frequency band to supplement downlink transmissions in a licensed frequency band. For example, a base station that operates according to LTE may transmit best effort data on a supplemental downlink channel in the unlicensed frequency band concurrently with transmitting control (and other critical) information on a channel of the licensed frequency band.

The nodes 104, 105 may use a channel selection algorithm to choose one or more of the unlicensed frequency band channels for downlink transmission. Some embodiments of the nodes 104, 105 may select unlicensed channels based on measurements of energy received over one or more of the channels for a predetermined time interval (e.g., long-term energy detection), detection of preambles such as Wi-Fi preambles received over the channels, detection of overhead broadcast channels from neighboring nodes, and the like. In the illustrated embodiment, the nodes 104, 105 are within the boundaries of the cells 110, 115 of the other nodes. For example, the node 104 falls within the boundary of the cell 115 and the node 105 falls within the boundary of the cell 110. The nodes 104, 105 may therefore detect each other over the air interface and may perform measurements to determine whether the other node is transmitting in one or more channels of the unlicensed frequency band.

The nodes 104, 105 may transmit downlink signals over clear channels in the unlicensed frequency band. As used herein, the term “clear” is understood to indicate that a measured value of a parameter of signals in the unlicensed frequency band (such as a signal-to-noise ratio, received signal strength indicator, and the like) is below a threshold value indicating that the unlicensed frequency band is clear of transmissions by other nodes and packets transmitted over a channel of the unlicensed frequency band are unlikely to collide with packets transmitted by other nodes. For example, if the node 104 does not detect downlink transmissions from the node 105 on a channel of the unlicensed frequency band, the node 104 may use the channel of the unlicensed frequency band for downlink transmissions.

However, if the nodes 104, 105 are not able to find a clear channel in the unlicensed frequency band, the nodes 104, 105 may share the channel with one or more other nodes. The nodes 104, 105 may therefore select time intervals for downlink transmissions by the nodes 104, 105 over the shared channel of the unlicensed frequency band. Some embodiments of the nodes 104, 105 select a first portion of a gating cycle for transmission over a channel of the unlicensed frequency band in response to determining that the channel is clear of transmissions from other nodes and a second portion of the gating cycle that is time division multiplexed with the first portion in response to determining that the channel is shared with at least one other node. For example, the node 104 may select the first half of the gating cycle if the node 105 is not transmitting on a channel and the node 105 may subsequently select the second half of the gating cycle for transmission in response to determining that the node 104 is already transmitting on the channel.

In the illustrated embodiment, the nodes 104, 105 are connected by an interface 120 such as a backhaul interface. One example of a backhaul interface is the X2 interface defined by the Third Generation Partnership Project (3GPP) standards. Some embodiments of the nodes 104, 105 may therefore exchange messages over the interface 120 to negotiate the time intervals that are used by the nodes 104, 105 for downlink transmissions, as discussed herein. Although FIG. 1 depicts a single pair of nodes 104, 105 that are connected by an interface 120, some embodiments of the wireless communication system 100 may include larger numbers of nodes that are interconnected by additional interfaces that may be used to negotiate time intervals for sharing channels of the unlicensed frequency band, as discussed herein.

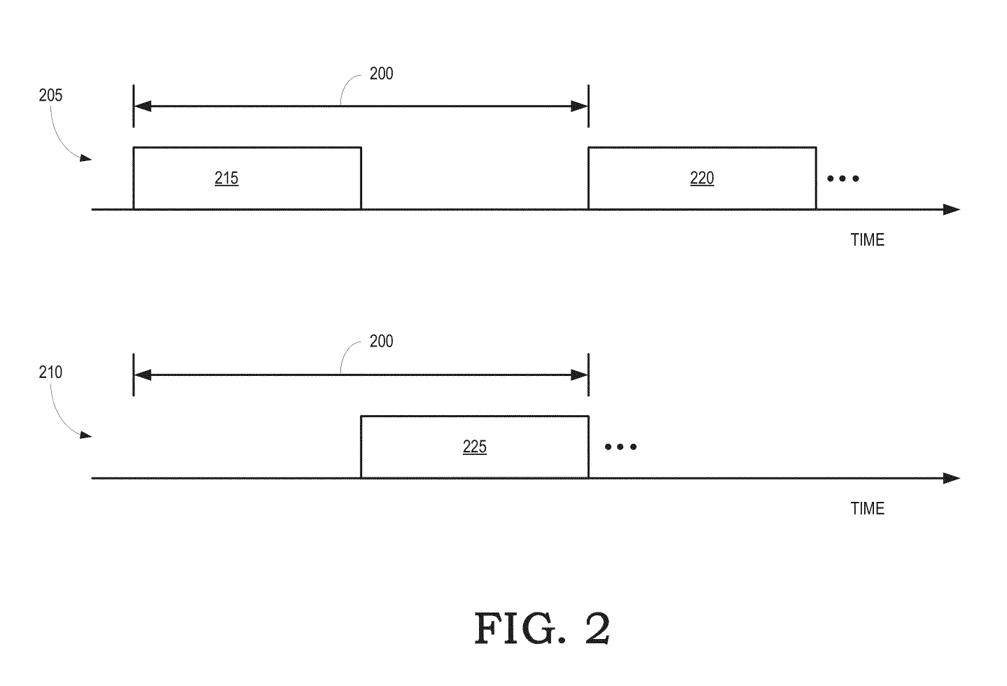

FIG. 2 is a diagram showing allocation of time intervals in a gating cycle 200 for downlink transmissions by two nodes on a channel of an unlicensed frequency band according to some embodiments. The gating cycle 200 may repeat indefinitely or for a predetermined amount of time. A first allocation 205 indicates time intervals in the gating cycle 200 that are allocated to a first node (such as the node 104 shown in FIG. 1) and a second allocation 210 indicates time intervals in the gating cycle 200 that are allocated to a second node (such as a node 105 shown in FIG. 1). The horizontal axes indicate time increasing from left to right. The first and second nodes operate according to the same radio access technology (RAT) and so they can share the entire gating cycle 200. For example, the first and second nodes may transmit downlink signals on the channel of the unlicensed frequency band according to LTE.

The time interval 215 in the gating cycle 200, as well as the time interval 220 in the subsequent gating cycle in a series of repeating gating cycles, maybe allocated to the first node for downlink transmissions on the channel of the unlicensed frequency band. The time interval 225 in the gating cycle 200 may be allocated to the second node for downlink transmissions on the channel of the unlicensed frequency band. Consequently, downlink transmissions by the first and second node may not interfere with each other during the gating cycle 200. As discussed herein, the second node may select the time interval 225 in response to determining that the first node is already transmitting on the channel. Some embodiments of the first and second nodes may negotiate for the time intervals 215, 220, 225 by exchanging messages over an interface such as the interface 120 shown in FIG. 1.

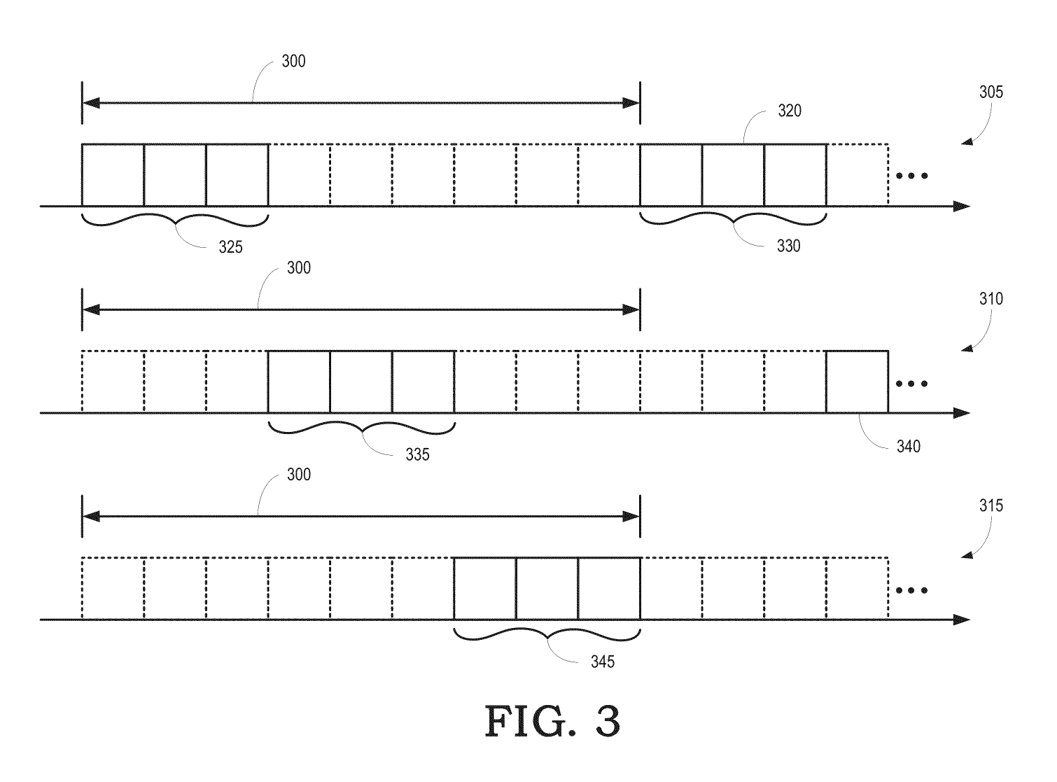

FIG. 3 is a diagram showing allocation of time intervals in a gating cycle 300 for downlink transmissions by three nodes on a channel of an unlicensed frequency band according to some embodiments. The gating cycle 300 may repeat indefinitely or for a predetermined amount of time. A first allocation 305 indicates time intervals in the gating cycle 300 that are allocated to a first node (such as the node 104 shown in FIG. 1), a second allocation 310 indicates time intervals in the gating cycle 300 that are allocated to a second node (such as a node 105 shown in FIG. 1), and a third allocation 315 indicates time intervals in the gating cycle 300 that are allocated to a third node. The horizontal axes indicate time increasing from left to right. The first, second, and third nodes operate according to the same RAT and so they can share the entire gating cycle 300. For example, the first, second, and third nodes may transmit downlink signals on the channel of the unlicensed frequency band according to LTE.

The gating cycle 300 is subdivided into time slots 320 (only one indicated by a reference numeral in the interest of clarity) that can be allocated to the first, second, or third nodes for downlink transmissions on the channel of the unlicensed frequency band. The first, second, and third nodes may therefore negotiate by exchanging information over interfaces between the first, second, and third nodes. The negotiation protocol is a matter of design choice. In the illustrated embodiment, the first, second, and third nodes have negotiated over the interfaces to allocate a subset 325 of the timeslots in the gating cycle 300, as well as a subset 330 of the timeslots in the subsequent gating cycle, to the first node. The dotted lines indicate time slots that are not allocated to the first node. As a result of the negotiations, the subset 335 in the gating cycle 300, as well as the timeslot 340 in the subsequent gating cycle, are allocated to the second node and the subset 345 is allocated to the third node.

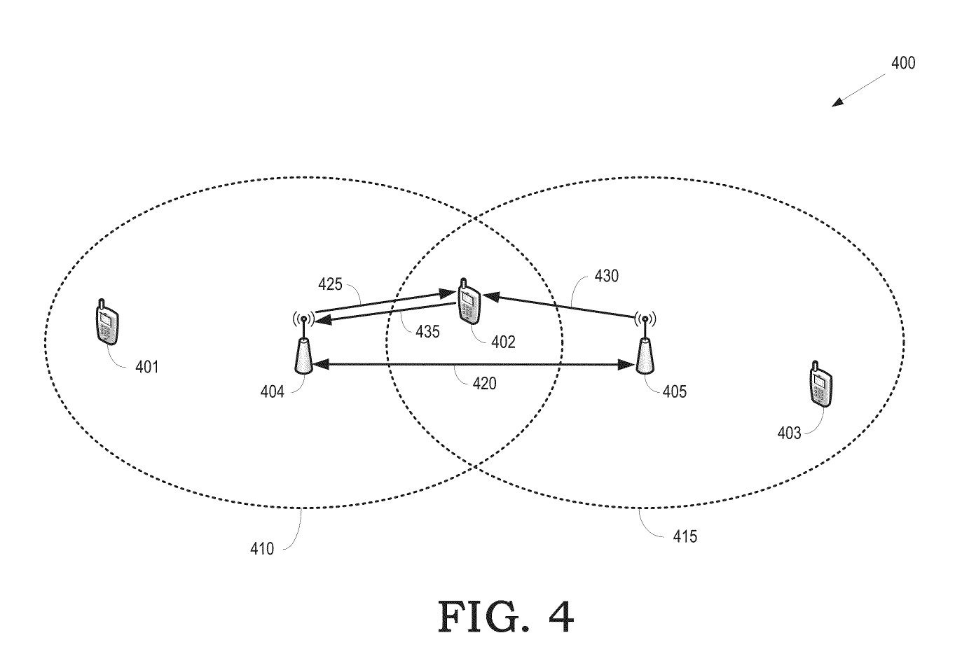

FIG. 4 is a diagram of a second example of a wireless communication system 400 according to some embodiments. The wireless communication system 400 includes a plurality of wireless communication nodes 401, 402, 403, 404, 405 (collectively referred to herein as “the nodes 401-405”). Embodiments of the nodes 401-403 may be wireless transceivers such as user equipment, mobile units, mobile terminals, stations, access terminals, and the like. Embodiments of the nodes 404, 405 may be devices for providing wireless connectivity within corresponding cells 410, 415. The nodes 404, 405 may be connected by an interface 420 such as a backhaul interface. Some embodiments of the elements 401-405, 410, 415, 420 shown in FIG. 4 may correspond to the elements 101-105, 110, 115, 120 shown in FIG. 1. However, the embodiment shown in FIG. 4 differs from the embodiment shown in FIG. 1 because the nodes 404, 405 are not encompassed by the boundaries of both of the cells 410, 415. Consequently, the nodes 404, 405 may not be able to detect each other's downlink transmissions on channels of unlicensed frequency bands. The nodes 404, 405 are therefore “hidden” from each other.

Nodes 401-403 may assist the nodes 404, 405 by informing the nodes 404, 405 of interfering downlink transmissions on channels of the unlicensed frequency bands. The nodes 401-403 may monitor channels of the unlicensed frequency bands based on information received from one or more of the nodes 404, 405. For example, the node 404 may measure signal strengths for transmissions received on a set of channels of the unlicensed frequency band and rank the channels based on the measured signal strength. The node 404 may then identify a subset of the channels as candidates for downlink transmissions, with channels having the lowest measured signal strengths getting the highest ranking. The number of channels in the subset may range from a single channel to the number of channels in the unlicensed frequency band. The node 404 may then transmit one or more messages 425 to instruct the node 402 to measure one or more indicators (such as channel quality or received signal strengths) of downlink transmissions 430 on the subset of channels of the unlicensed frequency band. For example, the node 404 may instruct the node 402 to monitor the indicators during a measurement gap when the node 402 temporarily suspends transmission or reception with its serving node 404 to monitor signals from other nodes. The node 402 may transmit a message 435 reporting the results of the measurements.

The node 404 may then select a clear channel if the message 435 received from the node 402 indicates that one or more of the channels in the subset are clear. However, the node 404 may have to share the channel with the hidden node 405 if the message 435 received from the node 402 indicates that the channels are not clear, e.g., due to interfering downlink transmissions from the hidden node 405. Sharing the channel may include negotiating for a time interval in a gating cycle that is different than the time interval used by the hidden node 405 (as illustrated in FIG. 2) or negotiating with the hidden node 405 for a subset of time slots in the gating interval (as illustrated in FIG. 3).

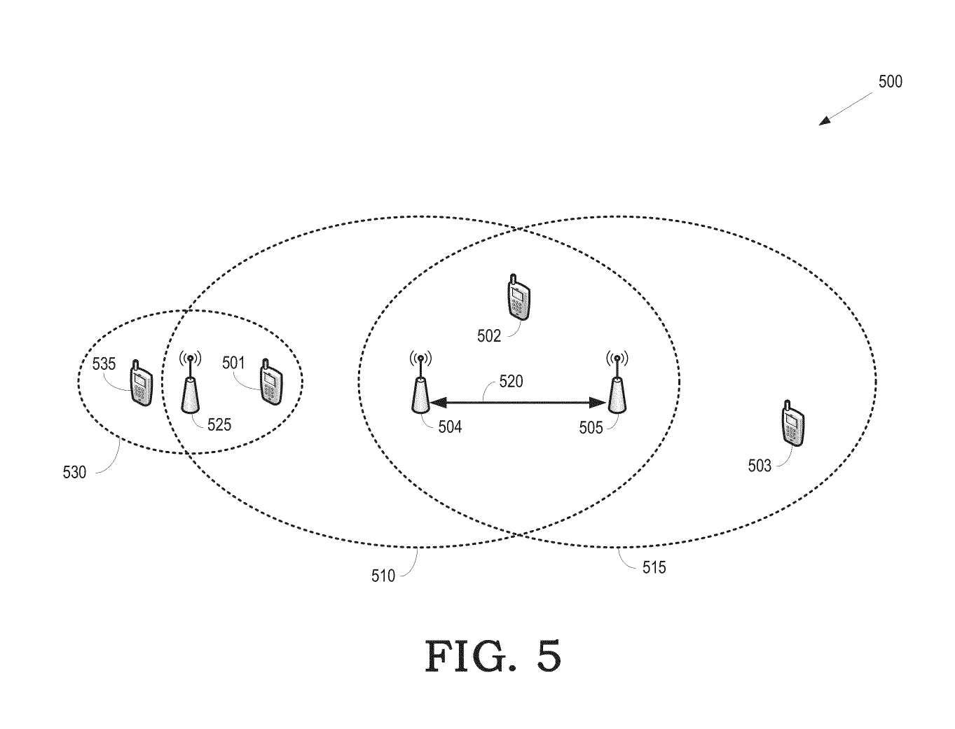

FIG. 5 is a diagram of a third example of a wireless communication system 500 according to some embodiments. The wireless communication system 500 includes a plurality of wireless communication nodes 501, 502, 503, 504, 505 (collectively referred to herein as “the nodes 501-505”). Embodiments of the nodes 501-503 may be wireless transceivers such as user equipment, mobile units, mobile terminals, stations, access terminals, and the like. Embodiments of the nodes 504, 505 may be devices for providing wireless connectivity within corresponding cells 510, 515. The nodes 504, 505 may be connected by an interface 520 such as a backhaul interface. Some embodiments of the elements 501-505, 510, 515, 520 shown in FIG. 5 may correspond to the elements 101-105, 110, 115, 120 shown in FIG. 1. However, the embodiment shown in FIG. 5 differs from the embodiment shown in FIG. 1 because the wireless communication system 500 includes a node 525 that provides wireless connectivity within a cell 530 according to a second RAT that differs from a first RAT used by the nodes 504, 505. For example, the node 525 may be a wireless access point that provides wireless connectivity according to a Wi-Fi standard and the nodes 504, 505 may provide wireless connectivity according to an LTE standard.

The boundary of the cell 530 associated with the node 525 does not encompass the node 504. Thus, the node 504 may not be able to detect the presence of the node 525 using measurements of signals received over the air interface. Some embodiments of the node 504 may therefore detect the presence of the node 525 by instructing the node 501 to monitor downlink transmissions from the node 525 (e.g., to node 535) during a measurement gap. The node 501 may then report the results of the measurements to the node 504, as discussed herein. In some embodiments, cells associated with nodes that operate according to the second RAT may encompass one or more of the nodes 504, 505, in which case the nodes 504, 505 may be able to detect the presence of nodes that operate according to the second RAT by measuring downlink transmissions without assistance from other nodes.

The nodes 504, 505 may mitigate interference by sharing channels of the unlicensed frequency band with each other and the node 525. Some embodiments of the nodes 504, 505 may reserve a predetermined fraction (or duty cycle) of a repeating gating cycle for downlink transmissions by the node 525 on channels of the unlicensed frequency band. For example, the nodes 504, 505 may bypass downlink transmissions on channels of the unlicensed frequency band during a 50% duty cycle in the gating cycle. Reserving the predetermined fraction of the repeating gating cycle for downlink transmissions by the node 525 may ensure fairness between downlink transmissions in the unlicensed frequency band by the nodes 504, 505 that operate according to the first RAT and downlink transmissions in the unlicensed frequency band by the node 525 that operates according to the second RAT. The nodes 504, 505 may then negotiate (using messages exchanged over the interface 520) to allocate time intervals or timeslots from the unreserved portion of the gating cycle for downlink transmissions on the channels of the unlicensed frequency band that are being shared with the node 525. Some embodiments of the node 505 may transmit downlink signals in the unlicensed frequency band during the reserved predetermined fraction of the repeating gating cycle if the node 505 does not detect (either by measurements or reports from an associated node) the node 525. However, the node 505 should vacate the reserved portion of the repeating gating cycle as soon as it detects the presence of the node 525 or another node that operates using the second RAT.

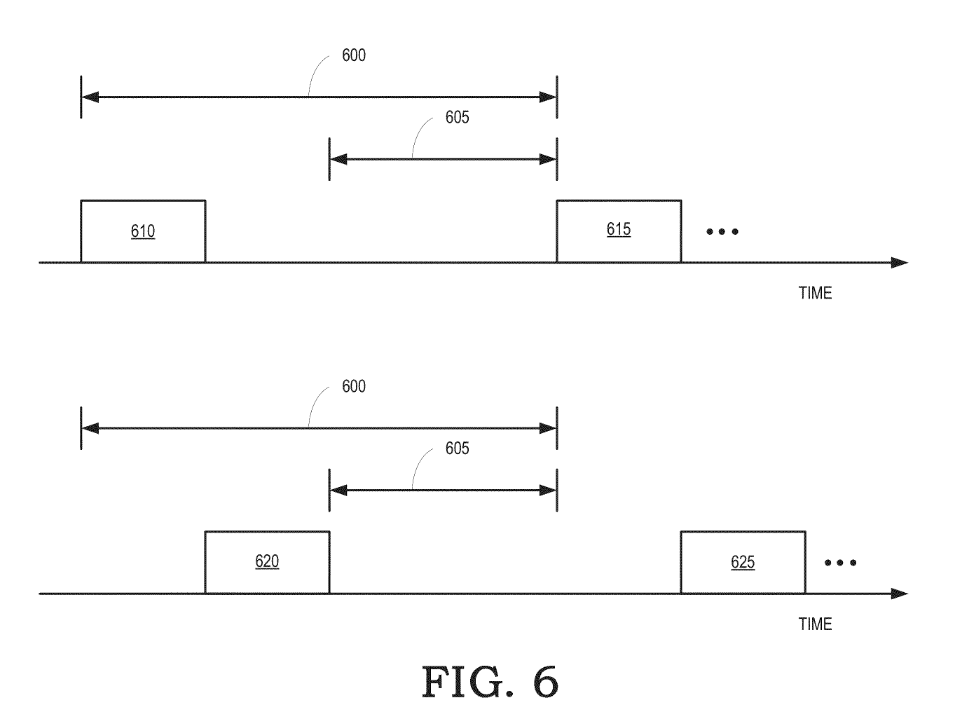

FIG. 6 is a diagram showing allocation of time intervals in a gating cycle 600 for downlink transmissions by two nodes that operate according to a first RAT and a third node that operates according to a second RAT according to some embodiments. The gating cycle 600 may repeat indefinitely or for a predetermined amount of time. First and second nodes that operate according to a first RAT have detected the presence of a third node that operates according to a second RAT. The third node is transmitting downlink signals over a shared channel of an unlicensed frequency band. In some embodiments, the first, second, and third nodes may correspond to the nodes 504, 505, 525 shown in FIG. 5. The first and second nodes therefore reserve a predetermined time interval 605 for downlink transmissions by the third node. For example, the predetermined time interval 605 may correspond to a 50% duty cycle. The first and second nodes bypass downlink transmissions on the shared channel during the predetermined time interval 605.

The first and second nodes negotiate allocation of the unreserved portion of the gating cycle 600, e.g., using messages transmitted over an interface between the first and second nodes. As a result of the negotiation, the first node is allocated a time interval 610 in unreserved portion of the gating cycle 600, as well as the time interval 615 in the subsequent gating cycle, for downlink transmissions over the shared channel of the unlicensed frequency band. The second node is allocated a time interval 620 in the unreserved portion of the gating cycle 600, as well as the time interval 625 in the subsequent gating cycle, for downlink transmission over the shared channel. In some embodiments, the time intervals 610, 615, 620, 625 may include one or more timeslots such as the time slots 320 shown in FIG. 3. Timeslots in the unreserved portion of the gating cycle 600 may therefore be allocated to more than two nodes that share the channel of the unlicensed frequency band and operate according to the first RAT.

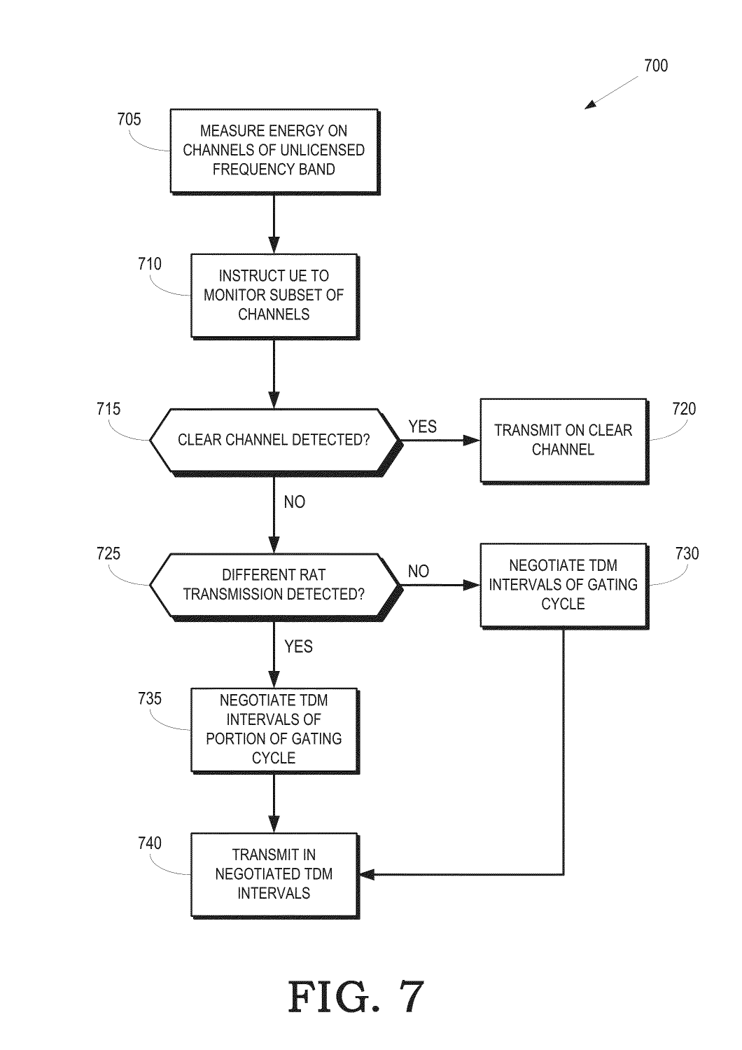

FIG. 7 is a flow diagram of a method 700 for negotiating allocation of time intervals to mitigate interference on a shared channel in an unlicensed frequency band according to some embodiments. The method 700 may be implemented in some embodiments of the nodes 104, 105 shown in FIG. 1, the nodes 404, 405 shown in FIG. 4, or the nodes 504, 505 shown in FIG. 5. Negotiations between the nodes may be performed over interfaces such as the interface 120 shown FIG. 1, the interface 420 shown in FIG. 4, or the interface 520 shown in FIG. 5. At block 705, a node measures energy on one or more channels in the unlicensed frequency band. At block 710, the node may (optionally) instruct one or more user equipment to monitor a subset of the channels in the unlicensed frequency band. For example, the node may rank the channels based on the measured energy received over a time interval so that channels with the lowest received energy (which are most likely to be clear for downlink transmission) receive the highest ranking and channels with the highest received energy (which are least likely to be clear for downlink transmission) receive the lowest ranking User equipment may then (optionally) monitor the subset of channels to determine whether one or more (possibly hidden) nodes are transmitting on one or more of the subset of channels. The user equipment may report the results of monitoring to the node.

At decision block 715, the node determines whether a clear channel has been detected for downlink transmissions. For example, the node may determine that a clear channel has been detected if one of the channels as a measured received energy that is below a threshold. The node may also confirm that the channel is clear if user equipment returns a report indicating that no channels are transmitting on the candidate clear channel. If a clear channel has been detected, the node may transmit downlink signals on the clear channel at block 720. If the node does not detect a clear channel, then the node may have to share one of the channels in the unlicensed frequency band with one or more other nodes. The other nodes may or may not operate according to the same RAT. For example, the node may operate according to a first RAT such as LTE and the other nodes may operate according to the first RAT or a second RAT such as Wi-Fi.

At decision block 725, the node determines whether one or more of the other nodes that are sharing the channel in the unlicensed frequency band operate according to the first RAT or the second RAT. If the node determines (using measurements or reports from user equipment) that the other nodes are transmitting according to the first RAT and none of the other nodes are transmitting according to a different (second) RAT, the node may negotiate (at 730) time intervals for time division multiplexing (TDM) of a repeating gating cycle for the shared channel. The time intervals may span the entire gating cycle and may be represented by timeslots. If the node determines (at decision block 725) that one or more of the other nodes are transmitting according to a different (second) RAT, the node may reserve (and bypass transmission during) a predetermined time interval in the gating cycle for downlink transmission according to the second RAT. The nodes that operate according to the first RAT may then negotiate (at 735) TDM time intervals in the unreserved portion of the gating cycle. At block 740, the nodes may transmit downlink signals over the shared channel of the unlicensed frequency band during the negotiated TDM time intervals.

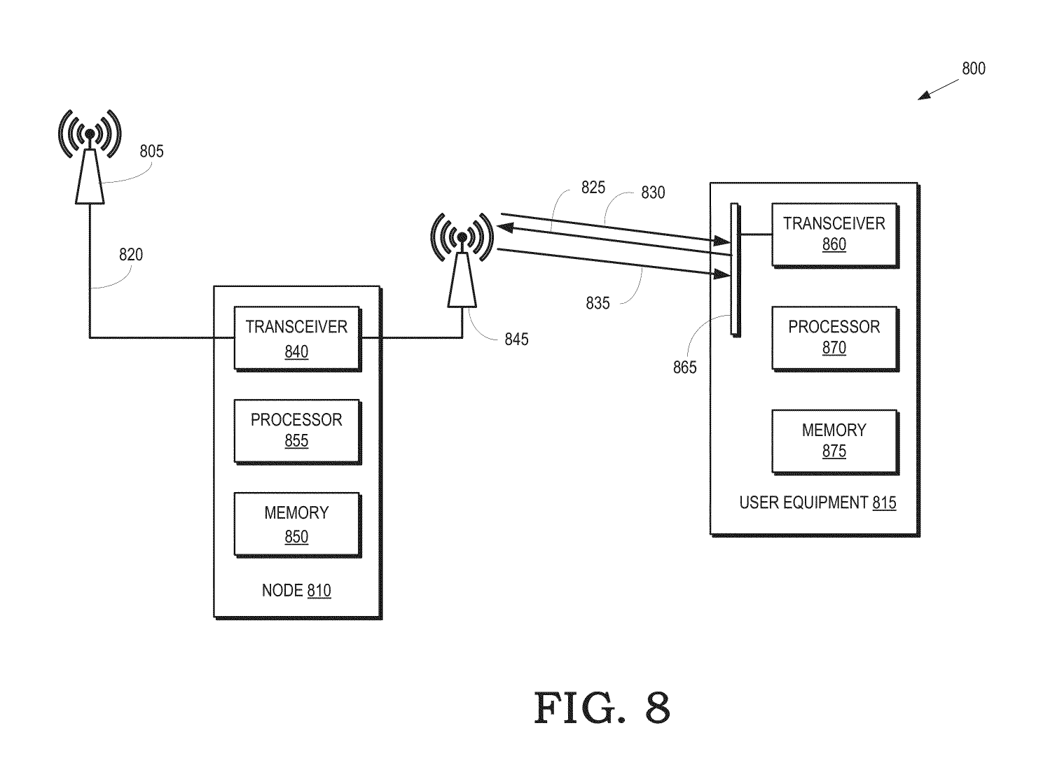

FIG. 8 is a diagram of a fourth example of a wireless communication system 800 according to some embodiments. The wireless communication system 800 includes nodes 805, 810 that may support wireless connectivity, e.g., to a node such as user equipment 815. The nodes 805, 810 may exchange messages over an interface 820. Some embodiments of the nodes 805, 810 or the user equipment 815 may correspond to one or more of the nodes 101-105 shown in FIG. 1, the nodes 401-405 shown in FIG. 4, or the nodes 501-505 shown in FIG. 5. The node 810 and the user equipment 815 may communicate over one or more uplink channels 825 and one or more downlink channels 830 in a licensed frequency band. The node 810 and the user equipment 815 may also communicate over a supplementary downlink channel 835 in an unlicensed frequency band.

Some embodiments of the node 810 include a transceiver 840 that is coupled to an antenna 845. The transceiver 840 may transmit signals over the downlink channels 830 in the licensed frequency band or the supplementary downlink channel 835 in the unlicensed band. The transceiver 840 may also receive signals over the uplink channels 825. Some embodiments of the transceiver 840 may transmit or receive messages over the interface 820. The node 810 includes memory 850 for storing information such as processor instructions, data for transmission, received data, and the like. A processor 855 may be used to process information for transmission, process received information, or perform other operations as discussed herein, e.g., by executing instructions stored in the memory 850. The processor 855 may also be used to negotiate allocation of time intervals to mitigate interference on a shared channel in an unlicensed frequency band. For example, the processor 855 may execute instructions stored in the memory 850 that are representative of the method 700 shown in FIG. 7. The node 805 may include the same functionality as the node 810.

Some embodiments of the user equipment 815 include a transceiver 860 that is coupled to an antenna 865. The transceiver 860 may transmit signals over the uplink channel 825 in the licensed frequency band. The transceiver 860 may receive signals over the downlink channel 830 in the licensed frequency band and the supplementary downlink channel 835 in the unlicensed frequency band. For example, the transceiver 860 may receive (over the downlink channel 830) messages requesting that the user equipment 815 monitor a subset of channels in the unlicensed frequency band. The transceiver 860 may report the results of monitoring the subset of channels over the uplink channel 825. The user equipment 815 also includes a processor 870 and a memory 875. The processor 870 may be used to process information for transmission, process received information, or perform other operations as discussed herein, e.g., by executing instructions stored in the memory 875.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
negotiating, based on messages exchanged over an interface between a first node and at least one second node, time intervals for downlink transmissions by the first node and the at least one second node over a channel of an unlicensed frequency band in response to the at least one second node transmitting over the channel of the unlicensed frequency band.

2. The method of claim 1, wherein negotiating the time intervals comprises selecting, at the first node, a first portion of a repeating gating cycle for downlink transmissions by the first node over the channel, wherein the first portion differs from a second portion of the repeating gating cycle used for downlink transmissions by the at least one second node.

3. The method of claim 1, wherein negotiating the time intervals comprises negotiating the time intervals for downlink transmissions by the first node and the at least one second node using messages exchanged over at least one backhaul interface between the first node and the at least one second node.

4. The method of claim 3, wherein the at least one second node comprises a plurality of second nodes, and wherein the first node and a first subset of the plurality of second nodes operate according to a first radio access technology (RAT), and wherein negotiating the time intervals comprises negotiating at least one first time interval in a repeating gating cycle for downlink transmissions over the channel by the first node and at least one second time interval in the repeating gating cycle for downlink transmissions over the channel by the first subset of the plurality of second nodes, wherein the at least one first time interval is time division multiplexed with the at least one second time interval.

5. The method of claim 4, wherein a second subset of the plurality of second nodes operate according to a second RAT, and wherein negotiating the time intervals comprises reserving a first portion of the repeating gating cycle for downlink transmissions by the second subset of the plurality of second nodes and negotiating the at least one first time interval in a second portion of the repeating gating cycle for downlink transmissions over the channel by the first node and the at least one second time interval in the second portion of the repeating gating cycle for downlink transmissions over the channel by the first subset of the plurality of second nodes.

6. The method of claim 5, wherein the first RAT operates according to Long Term Evolution (LTE) standards and wherein the second RAT operates according to Wi-Fi standards.

7. The method of claim 1, further comprising:
measuring at least one indicator of downlink transmissions on the channel of the unlicensed frequency band; and
determining that the at least one second node is transmitting over the channel of the unlicensed frequency band based on a measured value of the indicator.

8. The method of claim 1, further comprising:
instructing at least one user equipment to measure at least one indicator of downlink transmissions on the channel of the unlicensed frequency band; and
determining that the at least one second node is transmitting over the channel of the unlicensed frequency band in response to the at least one user equipment reporting results of the measurement of the at least one indicator of downlink transmissions.

9. The method of claim 1, further comprising:
transmitting at least one downlink signal from the first node over the channel in at least one of the negotiated time intervals.

10. An apparatus comprising:
a transceiver to exchange messages over an interface between a first node and at least one second node; and
at least one processor to negotiate, based on messages exchanged over an interface between a first node and at least one second node, time intervals for downlink transmissions by the first node and the at least one second node over a channel of an unlicensed frequency band in response to the at least one second node transmitting over the channel of the unlicensed frequency band.

11. The apparatus of claim 10, wherein the at least one processor is to select a first portion of a repeating gating cycle for downlink transmissions by the first node over the channel, wherein the first portion differs from a second portion of the repeating gating cycle used for downlink transmissions by the at least one second node.

12. The apparatus of claim 10, wherein the transceiver is to transmit or receive messages over at least one backhaul interface between the first node and the second node, and wherein the at least one processor is to select the time intervals for downlink transmissions by negotiating using messages exchanged over the at least one backhaul interface.

13. The apparatus of claim 12, wherein the at least one second node comprises a plurality of second nodes, and wherein the first node and a first subset of the plurality of second nodes operate according to a first radio access technology (RAT), and wherein the at least one processor is to negotiate at least one first time interval in a repeating gating cycle for downlink transmissions over the channel by the first node and at least one second time interval in the repeating gating cycle for downlink transmissions over the channel by the first subset of the plurality of second nodes, wherein the at least one first time interval is time division multiplexed with the at least one second time interval.

14. The apparatus of claim 13, wherein a second subset of the plurality of second nodes operate according to a second RAT, and wherein the at least one processor is to reserve a first portion of the repeating gating cycle for downlink transmissions by the second subset of the plurality of second nodes, and wherein the at least one processor is to negotiate the at least one first time interval in a second portion of the repeating gating cycle for downlink transmissions over the channel by the first node and the at least one second time interval in the second portion of the repeating gating cycle for downlink transmissions over the channel by the first subset of the plurality of second nodes.

15. The apparatus of claim 14, wherein the first RAT operates according to Long Term Evolution (LTE) standards and wherein the second RAT operates according to Wi-Fi standards.

16. The apparatus of claim 10, wherein the transceiver is to transmit or receive messages over an air interface, wherein the at least one processor is to measure at least one indicator of downlink transmissions on the channel of the unlicensed frequency band based on signals received by the transceiver, and wherein the at least one processor is to determine that the at least one second node is transmitting over the channel of the unlicensed frequency band based on a measured value of the indicator.

17. The apparatus of claim 10, wherein the transceiver is to transmit or receive messages over an air interface, wherein the transceiver is to transmit at least one message instructing at least one user equipment to measure at least one indicator of downlink transmissions on the channel of the unlicensed frequency band, and wherein the at least one processor is to determine that the at least one second node is transmitting over the channel of the unlicensed frequency band in response to the at least one user equipment reporting results of the measurement of the at least one indicator of downlink transmissions.

18. The apparatus of claim 10, wherein the transceiver is to transmit at least one downlink signal from the first node over the channel in at least one of the negotiated time intervals.

19. A non-transitory computer readable medium embodying a set of executable instructions, the set of executable instructions to configure at least one processor to:
negotiate, based on messages exchanged over an interface between a first node and at least one second node, time intervals for downlink transmissions by the first node and the at least one second node over a channel of an unlicensed frequency band in response to the at least one second node transmitting over the channel of the unlicensed frequency band.

20. The non-transitory computer readable medium of claim 19, wherein the set of executable instructions is to configure the at least one processor to select the time intervals for downlink transmissions by negotiating using messages exchanged over at least one backhaul interface between the first node and the at least one second node.
